(19) United States
(12) Patent Application Publication
(10) Pub. No.: US 2016/0348570 A1
(43) Pub. Date: Dec. 1, 2016

(54) Fuel Combustion System, Nozzle for Prechamber Assembly Having Coolant Passage in Communication with Orifice Passage, and Method of Making Same

(71) Applicant: CATERPILLAR INC., Peoria, IL (US)

(72) Inventor: Martin Willi, Dunlap, IL (US)

(73) Assignee: CATERPILLAR INC., Peoria, IL (US)

(21) Appl. No.: 14/721,616

(22) Filed: May 26, 2015

(51) Int. Cl. F02B 19/18; F02B 19/12

(52) U.S. Cl. CPC F02B 19/18; F02B 19/12

(57) ABSTRACT

A nozzle for a prechamber assembly of an engine includes a hollow nozzle body which includes an outer surface, an inner surface, and an orifice surface. The outer surface defines an outer orifice opening and a coolant passage inlet opening. The inner surface defines an interior chamber and an inner orifice opening. The orifice surface defines an orifice passage extending between, and in communication with, the outer orifice opening and the inner orifice opening. The orifice passage is in communication with the interior chamber via the inner orifice opening. The orifice surface defines a coolant passage outlet opening which is in communication with the orifice passage. The nozzle body includes a coolant surface which defines a coolant passage within the nozzle body. The coolant passage extends between the coolant passage inlet opening and the coolant passage outlet opening and is in communication with the orifice passage.

### TECHNICAL FIELD

This patent disclosure relates generally to a fuel combustion system for an internal combustion engine and, more particularly, to a nozzle for a prechamber assembly for an internal combustion engine.

### BACKGROUND

One type of internal combustion engines typically employs cylinders which compress a fuel and air mixture such that, upon firing of a spark plug associated with each cylinder, the compressed mixture ignites. The expanding combustion gases resulting therefrom move a piston within the cylinder. Upon reaching an end of its travel in one direction within the cylinder, the piston reverses direction to compress another volume of the fuel and air mixture. The resulting mechanical kinetic energy can be converted for use in a variety of applications, such as, propelling a vehicle or generating electricity, for example.

Another type of internal combustion engine, known as a compression ignition engine, uses a highly-compressed gas (e.g., air) to ignite a spray of fuel released into a cylinder during a compression stroke. In such an engine, the air is compressed to such a level as to achieve auto-ignition of the fuel upon contact between the air and fuel. The chemical properties of diesel fuel are particularly well suited to such auto-ignition.

The concept of auto-ignition is not limited to diesel engines, however, and has been employed in other types of internal combustion engines as well. For example, a self-igniting reciprocating internal combustion engine can be configured to compress fuel in a main combustion chamber via a reciprocating piston. In order to facilitate starting, each main combustion chamber is associated with a prechamber, particularly useful in starting cold temperature engines. Fuel is injected into not only the main combustion chamber, but also the combustion chamber of the prechamber, as well, such that, upon compression by the piston, a fuel and air mixture is compressed in both chambers. A glow plug or other type of heater is disposed within the prechamber to elevate the temperature therein sufficiently to ignite the compressed mixture. The combustion gases resulting from the ignition in the prechamber are then communicated to the main combustion chamber.

Other types of internal combustion engines use natural gas as the fuel source and include at least one piston reciprocating within a respective cylinder. A spark plug is positioned within a cylinder head associated with each cylinder and is fired on a timing circuit such that upon the piston reaching the end of its compression stroke, the spark plug is fired to thereby ignite the compressed mixture.

In still further types of internal combustion engines, prechambers are employed in conjunction with natural gas engines. Given the extremely high temperatures required for auto-ignition with natural gas and air mixtures, glow plugs or other heat sources such as those employed in typical diesel engines can be ineffective. Rather, a prechamber is associated with each cylinder of the natural gas engine and is provided with a spark plug to initiate combustion within the prechamber which can then be communicated to the main combustion chamber. Such a spark-ignited, natural gas engine prechamber is provided in, for example, the 3600 series natural gas engines commercially available from Caterpillar Inc. of Peoria, Ill.

The trend continues to operate these engines under lean-burn conditions. Lean burn refers to the burning of fuel with an excess of air in an internal combustion engine (i.e. lean fuel/air ratio). The excess of air in a lean burn engine combusts more of the fuel and emits fewer unwanted emissions. However, the lean fuel/air ratio can make it difficult to consistently achieve complete and thorough combustion within the main combustion chamber.

The components of internal combustion engines can be subjected to very high temperatures. For example, the surfaces defining the orifices of the nozzle of a member of a fuel combustion system, such as a prechamber nozzle, for example, can be subjected to very high temperatures as a result of the flow and temperature characteristics of the fuel mixtures traveling therethrough. In the case of a prechamber assembly, the high temperatures can be caused by the velocity of the fuel/air mixture entering the nozzle through the orifices and the ignition flame front discharged from the nozzle out through the orifices. As a result, the high temperatures to which the orifices are subjected can cause degradation of the nozzle and impair the function of the nozzle over time.

U.S. Pat. No. 6,406,254 is entitled, “Cooling Circuit for Steam and Air-Cooled Turbine Nozzle Stage,” and is directed to a turbine vane segment that includes inner and outer walls with a vane extending therebetween. The vane includes leading and trailing edge cavities and intermediate cavities. An impingement plate is spaced from the outer wall to impingement-cool the outer wall. Post-impingement cooling air flows through holes in the outer wall to form a thin air-cooling film along the outer wall. Cooling air is supplied an insert sleeve with openings in the leading edge cavity for impingement-cooling the leading edge. Holes through the leading edge afford thin-film cooling about the leading edge. Cooling air is provided the trailing edge cavity and passes through holes in the side walls of the vane for thin-film cooling of the trailing edge. Steam flows through a pair of intermediate cavities for impingement-cooling of the side walls. Post-impingement steam flows to the inner wall for impingement-cooling of the inner wall and returns the post-impingement cooling steam through inserts in other intermediate cavities for impingement-cooling the side walls of the vane.

There is a continued need in the art to provide additional solutions to enhance the performance of components of a fuel combustion system such as those in a prechamber assembly. For example, high temperatures in the orifice area of a gas engine prechamber nozzle can limit its service life and negatively affect the prechamber assembly's allowable design parameters. As such, there is a continued need to enable a prechamber assembly of a fuel combustion system to operate so as to enhance the combustion of fuel within the system while managing the heat generated during use of the prechamber assembly to improve its durability and usefulness.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### SUMMARY

In an embodiment, the present disclosure describes a nozzle for a prechamber assembly of an engine. The nozzle includes a nozzle body which is hollow and has an outer surface, an inner surface, and an orifice surface. The outer surface defines an outer orifice opening and a coolant passage inlet opening. The inner surface defines an interior chamber and an inner orifice opening.

The orifice surface defines an orifice passage extending between, and in communication with, the outer orifice opening and the inner orifice opening. The orifice passage is in communication with the interior chamber via the inner orifice opening. The orifice surface defines a coolant passage outlet opening which is in communication with the orifice passage.

The nozzle body includes a coolant surface which defines a coolant passage within the nozzle body. The coolant passage extends between, and in communication with, the coolant passage inlet opening and the coolant passage outlet opening. The coolant passage is in communication with the orifice passage.

In yet another embodiment, a fuel combustion system includes a cylinder housing and a prechamber assembly. The cylinder housing defines a main combustion chamber. The prechamber assembly is in communication with the main combustion chamber. The prechamber assembly defines a precombustion chamber which is in communication with the main combustion chamber.

The prechamber assembly includes a prechamber housing, an ignition device adapted to selectively ignite a fuel supply disposed in the precombustion chamber, and a nozzle. The ignition device is mounted to the prechamber housing. The nozzle is adjacent the prechamber housing. The nozzle at least partially defines the precombustion chamber.

The nozzle includes a nozzle body which is hollow and includes an outer surface, an inner surface, and an orifice surface. The outer surface defines an outer orifice opening and a coolant passage inlet opening. The inner surface defines an interior chamber and an inner orifice opening. The orifice surface defines an orifice passage extending between, and in communication with, the outer orifice opening and the inner orifice opening. The orifice passage is in communication with the interior chamber via the inner orifice opening and with the main combustion chamber via the outer orifice opening. The orifice surface defines a coolant passage outlet opening which is in communication with the orifice passage.

The nozzle body includes a coolant surface which defines a coolant passage within the nozzle body. The coolant passage extends between, and in communication with, the coolant passage inlet opening and the coolant passage outlet opening. The coolant passage is in communication with the orifice passage.

In still another embodiment, a method of making a nozzle for a prechamber assembly of an engine is described. The method of making includes manufacturing a nozzle body. The nozzle body is hollow and includes an outer surface and an inner surface. The inner surface defines an interior chamber.

An orifice surface is defined in the nozzle body. The orifice surface defines an orifice passage extending between, and in communication with, an outer orifice opening defined in the outer surface and an inner orifice opening defined in the inner surface. The orifice passage is in communication with the interior chamber via the inner orifice opening.

A coolant surface is defined in the nozzle body. The coolant surface defines a coolant passage within the nozzle body. The coolant passage extends between, and in communication with, a coolant passage inlet opening defined in the outer surface and a coolant passage outlet opening defined in the orifice surface. The coolant passage is in communication with the orifice passage.

Further and alternative aspects and features of the disclosed principles will be appreciated from the following detailed description and the accompanying drawings. As will be appreciated, the principles related to fuel combustion systems, prechamber assemblies, and methods of making nozzles for prechamber assemblies disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a diagrammatic, longitudinal cross-sectional view of an embodiment of a fuel combustion system constructed in accordance with principles of the present disclosure and including an embodiment of a prechamber assembly constructed in accordance with principles of the present disclosure.

FIG. 2 is a first elevational view of an embodiment of a prechamber nozzle constructed in accordance with principles of the present disclosure, the prechamber nozzle being suitable for use in embodiments of a prechamber assembly following principles of the present disclosure.

FIG. 3 is a second elevational view of the prechamber nozzle of FIG. 2, the second elevational view being circumferentially offset about a central longitudinal axis of the prechamber nozzle relative to the view in FIG. 2 by thirty degrees in a clockwise direction.

FIG. 4 is a cross-sectional view of the prechamber nozzle of FIG. 2 taken along line IV-IV in FIG. 2.

FIG. 5 is a cross-sectional view of the prechamber nozzle of FIG. 2 taken along line V-V in FIG. 3.

FIG. 6 is a flowchart illustrating steps of an embodiment of a method of making a nozzle for a prechamber assembly of an engine following principles of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

The present disclosure provides embodiments of a component of a fuel combustion system of an engine and methods of making the same. In embodiments, the fuel combustion component is in the form of a nozzle of a prechamber assembly which can be mounted to at least one of a cylinder head or cylinder block of an internal combustion engine. Exemplary engines include those used in vehicles, electrical generators, and pumps, for instance.

Embodiments of a nozzle for a prechamber assembly constructed according to principles of the present disclosure can have a nozzle body that includes at least one coolant passage configured to help protect an orifice defined within the nozzle body from the deleterious effects of the flow of an air-fuel mixture into the prechamber nozzle and/or a flame front discharging from the prechamber nozzle alternatingly passing through the orifice of the nozzle during intended operation of the fuel combustion system. In embodiments, the nozzle can include at least one coolant passage in communication with an orifice passage defined within the nozzle body. A source of cooling medium can be placed in fluid communication with the coolant passage and configured such that the source of cooling medium flows through the coolant passage into the orifice passage to provide an insulating film between the orifice surface defining the orifice passage and the hot burning gases being discharged from the interior chamber of the nozzle.

In embodiments, a nozzle constructed according to principles of the present disclosure defines a distribution reservoir therein. The nozzle body defines at least one coolant passage therein which is in fluid communication with the distribution reservoir, which in turn is in fluid communication with at least one orifice passage defined within the nozzle body. A cooling flow of a cooling medium is routed to the distribution reservoir within the nozzle body. The cooling medium is fed from the distribution reservoir to at least one orifice passage to create an insulating film between the orifice surface defining the orifice passage and the hot burning gases passing therethrough. Embodiments of a prechamber nozzle constructed according to principles of the present disclosure can be made using additive manufacturing techniques.

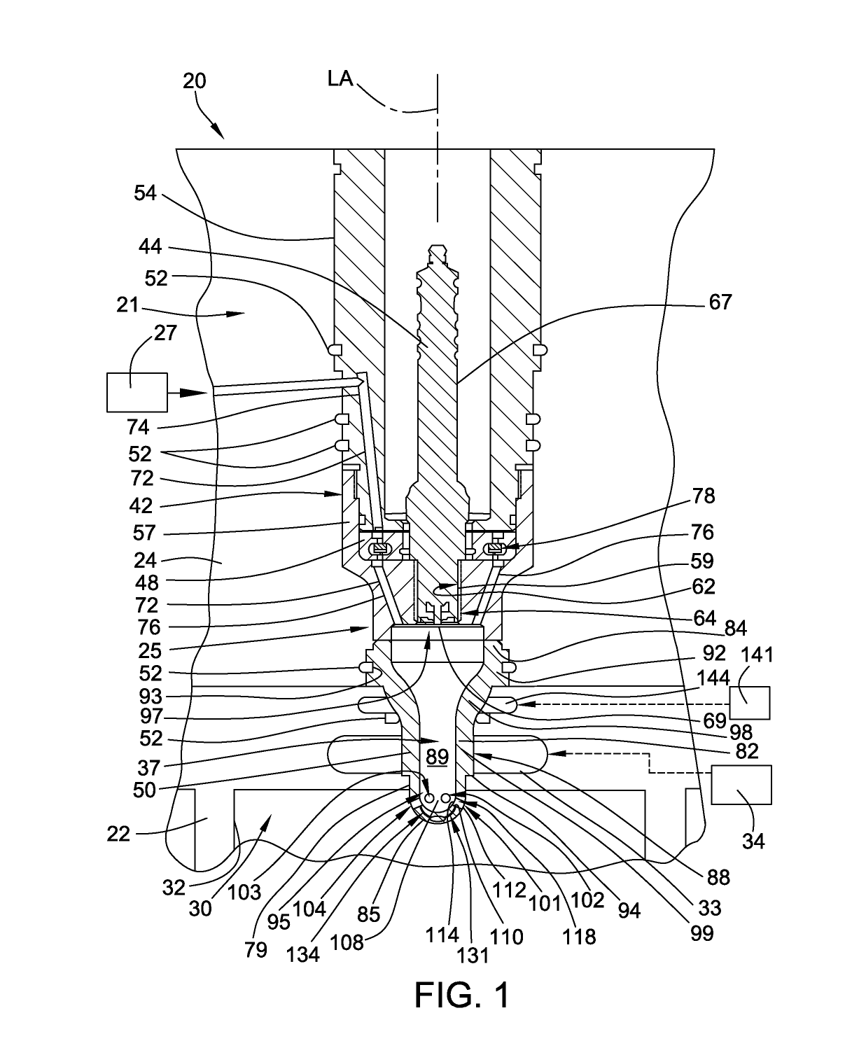

Turning now to the FIGURES, there is shown in FIG. 1 an exemplary embodiment of a fuel combustion system 20 constructed in accordance with principles of the present disclosure. The fuel combustion system 20 can be used in any suitable internal combustion engine, such as an engine configured as part of an electrical generator or a pump, for example. The fuel combustion system 20 can be used with any suitable fuel with an appropriate fuel/air ratio. In embodiments, fuels with different ignition and burning characteristics and different specific fuel to air ratios can be used. The fuel combustion system 20 can include a cylinder housing 21 that includes a cylinder block 22 and a cylinder head 24; a prechamber assembly 25 having a fuel combustion component in the form of a nozzle 50 constructed in accordance with principles of the present disclosure; a supplemental fuel source 27; and a variety of other combustion devices, as will be appreciated by one skilled in the art.

Referring to FIG. 1, the cylinder block 22 and the cylinder head 24 can be made from any suitable material, such as a suitable, heat-resistant metal, for example. The cylinder housing 21 defines a main combustion chamber 30. In embodiments, the cylinder block 22 of the cylinder housing 21 at least partially defines the main combustion chamber 30. In embodiments, the cylinder block 22 can define a plurality of cylinders 32 (one of which is shown in FIG. 1) within which is defined the corresponding main combustion chamber 30. In embodiments, a cylinder liner can be disposed within each cylinder 32. The cylinder liner can be removably secured in the cylinder block 22.

The cylinder head 24 can be removably attached to the cylinder block 22 via suitable fasteners, such as a plurality of bolts, as will be appreciated by one skilled in the art. A gasket (not shown) can be interposed between the cylinder block 22 and the cylinder head 24 to seal the interface therebetween. The cylinder head 24 typically has bores machined for engine valves (not shown), e.g., inlet and exhaust valves, and other components of the fuel combustion system 20 (not shown), e.g., fuel injectors, glow plugs, sparks plugs, and combinations thereof, as will be appreciated by one skilled in the art.

Each cylinder 32 of the cylinder block 22 can house a reciprocally movable piston (not shown), which is coupled to a crankshaft via a suitable transfer element (e.g., a piston rod or connecting rod). The piston is reciprocally movable within the cylinder 32 for compressing and thereby pressurizing the combustible mixture in the main combustion chamber 30 during a compression phase of the engine. In embodiments, the engine can be configured to have a suitable compression ratio suited for the intended purpose of the engine, as will be understood by one skilled in the art.

In embodiments, at least one intake valve mechanism (not shown) and at least one exhaust valve mechanism (not shown) can be operatively positioned within the cylinder head 24 such that the intake valve and the exhaust valve are axially movable in the cylinder head 24. In embodiments, a mechanical valve train (e.g., including a cam, follower, and push rod mechanism) or other hydraulic and/or electric control device can be used in a conventional manner to selectively operate the intake valve mechanism and the exhaust valve mechanism. In particular, the inlet valve mechanism can be opened to admit a predetermined amount of a lean gaseous combustible mixture of fuel and air directly into the main combustion chamber 30 above the piston during an intake phase of the engine. The exhaust valve mechanism can be opened to permit the exhaust of the gases of combustion from the main combustion chamber 30 during an exhaust phase of the engine.

In embodiments, at least one of the cylinder block 22 and the cylinder head 24 defines one or more coolant passages 33. Each coolant passage 33 can be adapted to be placed in communication with a source of coolant 34 and configured to cool one or more components of the fuel combustion system 20. In embodiments, the coolant can be any suitable kind, such as, a coolant fluid, for example. In embodiments, any suitable technique can be used to circulate coolant from the source of coolant 34 through the coolant passages 33 in the cylinder block 22 and/or the cylinder head 24.

The prechamber assembly 25 is removably secured in the cylinder head 24 such that the prechamber assembly 25 is in communication with the main combustion chamber 30. The prechamber assembly 25 defines a precombustion chamber 37, which is in communication with the main combustion chamber 30. The prechamber assembly 25 includes a prechamber housing 42, an ignition device 44 adapted to selectively ignite fuel disposed in the precombustion chamber 37, a control valve 48, and the nozzle 50. The nozzle 50 and the prechamber housing 42 can be made from any suitable material, such as a suitable heat-resistant metal.

Suitable sealing devices 52, such as o-rings, for example, can be disposed between the prechamber assembly 25 and the cylinder head 24. In other embodiments, other sealing techniques, such as, press fit, metal seals, and the like, can be used to provide a seal between the prechamber assembly 25 and the cylinder block 22 and the cylinder head 24.

In embodiments, the nozzle 50 at least partially defines the precombustion chamber 37. In the illustrated embodiment, the nozzle 50 is adjacent the prechamber housing 42. The nozzle 50 and the prechamber housing 42 cooperate together to define the precombustion chamber 37 and to define a central longitudinal axis LA of the prechamber assembly 25. The nozzle 50 and the prechamber housing 42 include surfaces that are generally surfaces of revolution about the central longitudinal axis LA.

The precombustion chamber 37 has a predetermined geometric shape and volume. In embodiments, the volume of the precombustion chamber 37 is smaller than the volume of the main combustion chamber 30. In some embodiments, the volume of the precombustion chamber 37 is in a range between about one and about four percent of the total combustion chamber volume at top dead center.

The prechamber housing 42 is hollow and is adapted to receive the ignition device 44 therein. In the illustrated embodiment, the prechamber housing 42 includes an upper member 54 and a lower member 57 which are threadingly secured together. In other embodiments, other types of engagement between the upper member 54 and the lower member 57 can be used, such as, welding, press fitting, and the like.

The ignition device 44 is mounted to the prechamber housing 42. The illustrated lower member 57 of the prechamber housing 42 defines an ignition device bore 59 which has an internal threaded surface 62. The ignition device 44 has an external threaded surface 64 which is threadedly engaged with the internal threaded surface 62 of the ignition device bore 59. The ignition device bore 59 is in communication with the precombustion chamber 37.

In the illustrated embodiment, the ignition device 44 comprises a spark plug 67 with an electrode 69. The spark plug 67 is removably mounted to the prechamber housing 42 such that the electrode 69 is in communication with the precombustion chamber 37. The spark plug 67 is threadedly received in the ignition device bore 59 with the electrode 69 exposed to the precombustion chamber 37 by way of the ignition device bore 59. The spark plug 67 can be adapted to be electrically energized in a conventional manner.

In embodiments, at least one of the prechamber housing 42 and the nozzle 50 define a supplemental fuel passage 72. The supplemental fuel passage 72 is in communication with the precombustion chamber 37 and with the supplemental fuel source 27. In embodiments, the fuel of the supplemental fuel source 27 can have a richer fuel/air ratio than the fuel/air ratio of the fuel supplied directly to the main combustion chamber 30 with which the prechamber assembly 25 is associated.

In the illustrated embodiment of FIG. 1, the upper member 54 and the lower member 57 of the prechamber housing 42 both define the supplemental fuel passage 72. The illustrated upper member 54 defines a fuel passage entry segment 74. The illustrated lower member 57 of the prechamber housing 42 defines a plurality of precombustion chamber fuel passage segments 76 which are circumferentially arranged about the lower member 57 and in fluid communication with the fuel passage entry segment 74 via a control valve cavity 78 defined between the upper member 54 and the lower member 57.

The control valve 48 is disposed within the prechamber housing 42 and is adapted to selectively occlude the supplemental fuel passage 72 to prevent a flow of fuel from the supplemental fuel source 27 to the precombustion chamber 37. The illustrated control valve 48 is disposed within the control valve cavity 78 and is interposed between the fuel passage entry segment 74 and the precombustion chamber fuel passage segments 76. The control valve 48 can be adapted to selectively permit the flow of fuel from the supplemental fuel source 27 into the precombustion chamber 37 of the prechamber assembly 25 to further promote ignition within the precombustion chamber 37. The control valve 48 can be adapted to open and close with the engine's combustion cycle to prevent contamination of the fuel with exhaust and/or prevent leakage of fuel into the exhaust gases. The control valve 48 can be adapted to prevent the gas product of combustion to flow from the precombustion chamber 37 to the fuel passage entry segment 74 of the supplemental fuel passage 72 during the compression, combustion, and exhaust phases of the engine.

In embodiments, the control valve 48 can be any suitable control valve, such as a check valve assembly including a free-floating ball check having an open mode position—permitting the flow of the fuel from the supplemental fuel source 27 to the precombustion chamber 37—and a closed mode position—preventing gas flow from the supplemental fuel source 27 to the precombustion chamber 37. In other embodiments, the control valve 48 can be a shuttle type check valve. In the illustrated embodiment, the control valve 48 is similar in construction and function to the check valve shown and described in U.S. Pat. No. 6,575,192.

The nozzle 50 is in communication with the main combustion chamber 30. The nozzle 50 includes a nozzle body 82 having a mounting end 84 and a distal tip 85. The nozzle body 82 defines the central longitudinal axis LA which extends between the mounting end 84 and the distal tip 85. The nozzle body 82 is hollow and includes an outer surface 88 and an inner surface 89. The outer surface 88 and the inner surface 89 are both surfaces of revolution about the central longitudinal axis LA.

The mounting end 84 of the nozzle 50 is in abutting relationship with the lower member 57 of the prechamber housing 42. The mounting end 84 of the nozzle body 82 includes an annular flange 92 that defines an external circumferential groove 93 configured to receive a suitable sealing device 52 (e.g., an o-ring) therein for sealing. Any suitable technique can be used to provide a seal between the nozzle 50 and the lower member 57 of the prechamber housing 42, such as, o-rings, press fit, metal seals, gaskets, welding, and the like.

The nozzle body 82 is positioned adjacent one of the coolant passages 33 such that coolant fluid circulating through the coolant passage 33 is in heat-transferring relationship with the nozzle body 82. The nozzle body 82 projects from the cylinder head 24 such that the distal tip 85 of the nozzle body 82 is disposed in the main combustion chamber 30 so that the distal tip 85 is in communicating relationship with the main combustion chamber 30. Any suitable sealing technique can be used to seal an interface 94 between the nozzle 50 and the cylinder block 22 and/or the cylinder head 24, such as, a gasket, a taper fit, and/or a press fit to isolate fuel, combustion gases, and engine coolant therein.

The inner surface 89 of the nozzle body 82 defines an interior chamber 95 which is open to and in communication with a distal cavity 97 defined in the lower member 57 of the prechamber housing 42. The interior chamber 95 of the nozzle body 82 and the distal cavity 97 of the lower member 57 together define the precombustion chamber 37 of the prechamber assembly 25. The interior chamber 95 of the nozzle body 82 is open to the electrode 69 of the spark plug 67 and is in fluid communication with the supplemental fuel passage 72 via the precombustion chamber fuel passage segments 76 of the lower member 57.

The mounting end 84 of the nozzle body 82 is generally cylindrical. The nozzle body 82 includes a converging portion 98 disposed adjacent the mounting end 84 and a distal cylindrical portion 99 adjacent the distal tip 85. The distal cylindrical portion 99 has a smaller diameter than that of the mounting end 84.

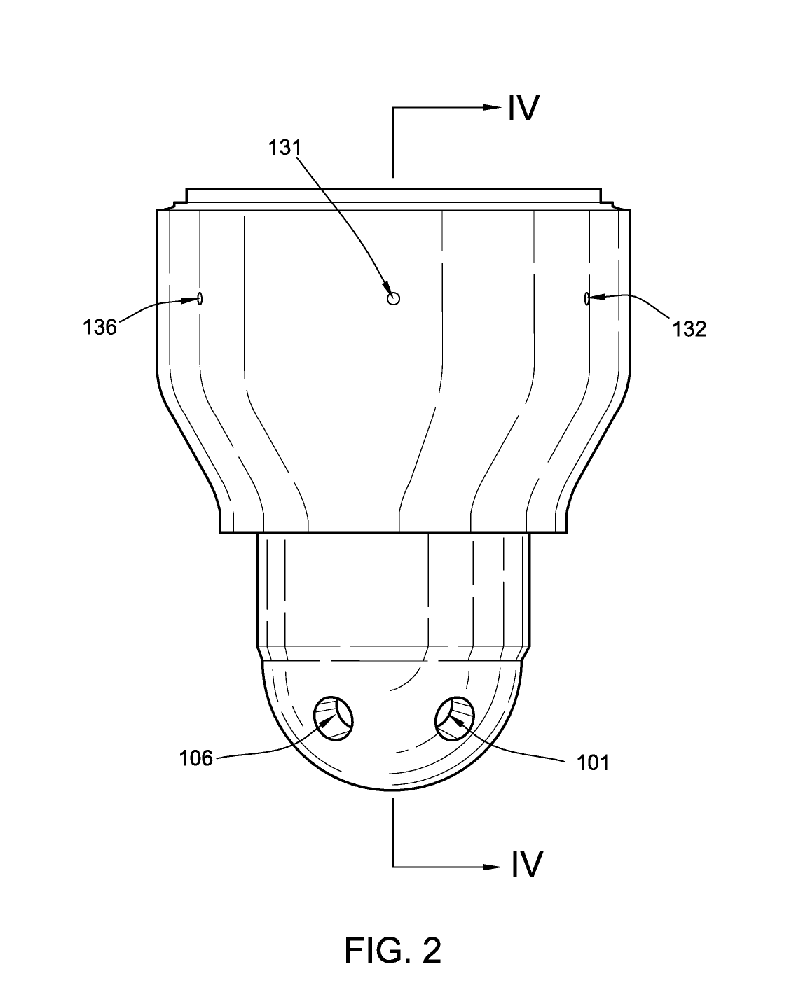

Referring to FIGS. 1 and 2, the nozzle body 82 defines a plurality of orifices 101, 102, 103, 104, 106 in the distal tip 85. The orifices 101, 102, 103, 104, 106 are in communication with the interior chamber 95 of the nozzle body 82, and with the main combustion chamber 30 when the prechamber assembly 25 is installed in the cylinder housing 21. The nozzle body 82 includes an orifice bridge 108 defined circumferentially between the orifices 101, 102, 103, 104, 106. The orifices 101, 102, 103, 104, 106 can be configured such that flows of burning fuel respectively conveyed from the interior chamber 95 out through the orifices 101, 102, 103, 104, 106 are controllably directed away from the nozzle body 82 in diverging relationship to each other, controllably expanding the burning gases away from the distal tip 85 of the nozzle 50 into the main combustion chamber 30 in order to facilitate the ignition and burning of the combustible mixture in the main combustion chamber 30 over a larger volume at the same time.

In embodiments, the nozzle body 82 can define any suitable number of orifices to achieve the desired flow characteristics within the interior chamber 95 of the nozzle body 82 and the desired flame discharge pattern in the main combustion chamber 30 resulting from the combustion phase in the nozzle 50. For example, in the illustrated embodiment, the nozzle body 82 includes six orifices (five of which are shown in FIGS. 1 and 2 with the other one being a mirror image of the second orifice 102 and in opposing relationship therewith). The orifices 101, 102, 103, 104, 106 are circumferentially arranged about the central longitudinal axis LA at substantially evenly-spaced angular positions (about sixty degrees apart from each other). The orifices 101, 102, 103, 104, 106 are axially aligned along the central longitudinal axis LA.

Referring to FIGS. 1 and 2, the illustrated orifices 101, 102, 103, 104, 106 are substantially identical to each other. Accordingly, it will be understood that the description of one orifice is applicable to the other orifices, as well.

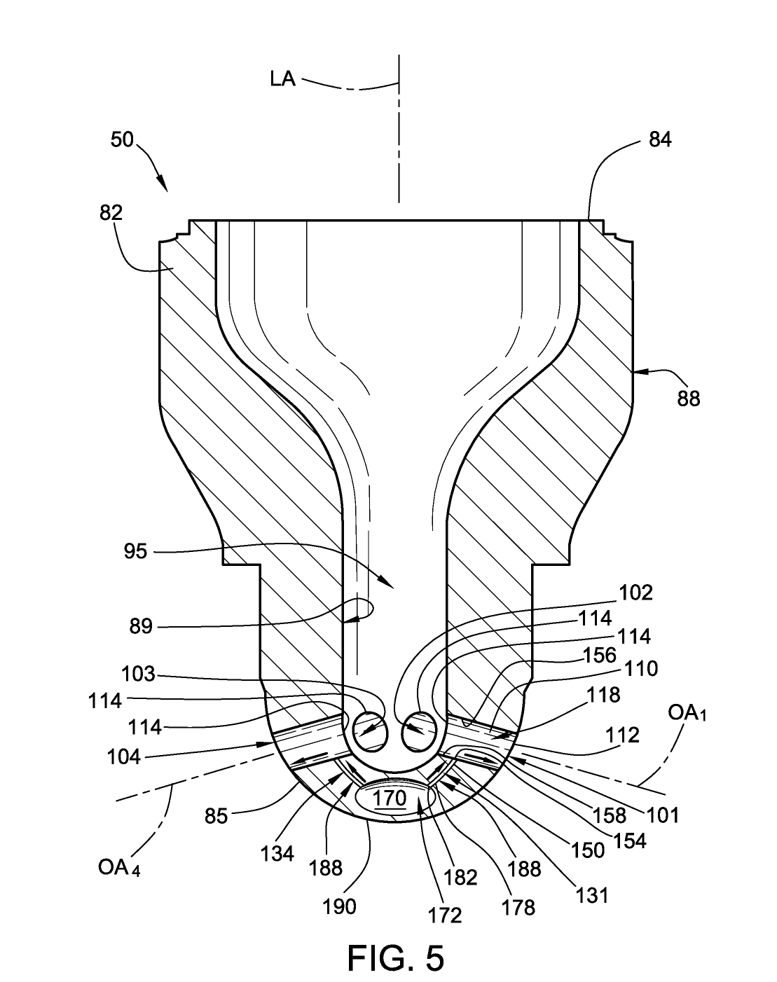

The first orifice 101 includes an orifice surface 110 that defines the orifice 101. The outer surface 88 defines an outer orifice opening 112, and the inner surface 89 defines an inner orifice opening 114. The orifice surface 110 defines an orifice passage 118 extending between, and in communication with, the outer orifice opening 112 and the inner orifice opening 114. The orifice passage 118 is in communication with the interior chamber 95 via the inner orifice opening 114 and, when installed in the fuel combustion system 20, with the main combustion chamber 30 via the outer orifice opening 112. The orifice surface 110 is disposed in the distal tip 85. In the illustrated embodiment, the orifice surface 110 extends along an orifice axis OA₁ between the inner orifice opening 114 and the outer orifice opening 112 (see FIG. 5). The other orifices 102, 103, 104, 106 of the nozzle body 82 are similarly configured.

In other embodiments, the nozzle body 82 can define a different number of orifices, such as eight or twelve orifices circumferentially arranged about the central longitudinal axis LA at substantially evenly-spaced angular positions (about forty-five degrees and about thirty degrees apart from each other, respectively). In still other embodiments, the nozzle body 82 can define yet a different number of orifices. In other embodiments, the nozzle body 82 can define orifices that have variable spacing between at least two pairs of adjacent orifices and/or be axially offset from at least one other orifice along the central longitudinal axis LA.

As shown in FIGS. 2 and 5, the orifices 101, 102, 103, 104, 106 are respectively circumferentially disposed about the central longitudinal axis LA such that the orifices 101, 102, 103, 104, 106 extend along an orifice axis OA₁, OA₄ between the respective inner and outer orifice openings 112, 114 that has the same relative inclined position with respect to the central longitudinal axis LA. In embodiments, the orifices 101, 102, 103, 104, 106 can extend along a different angle of inclination relative to the central longitudinal axis LA. In still other embodiments, at least one of the orifices 101, 102, 103, 104, 106 can extend along an angle of inclination relative to the central longitudinal axis LA that is different from at least one other of the orifices 101, 102, 103, 104, 106.

Referring to FIGS. 1, 4, and 5, in embodiments, the nozzle body 82 includes at least one coolant passage 131 configured to help protect an orifice 101 defined within the nozzle body 82 from the deleterious effects of the flow of an air-fuel mixture into the prechamber nozzle 50 and/or a flame front discharging from the prechamber nozzle 50 alternatingly passing through the orifice 101 of the nozzle 50 during the intended operation of the fuel combustion system 20. In embodiments, the nozzle body 82 can include at least one coolant passage 131 in communication with an orifice passage 118 defined within the nozzle body 82. In embodiments, the nozzle body 82 can define at least one coolant passage 131, 132, 134, 136 which is respectively in communication with at least one orifice 101, 102, 103, 104, 106 defined within the nozzle body 82.

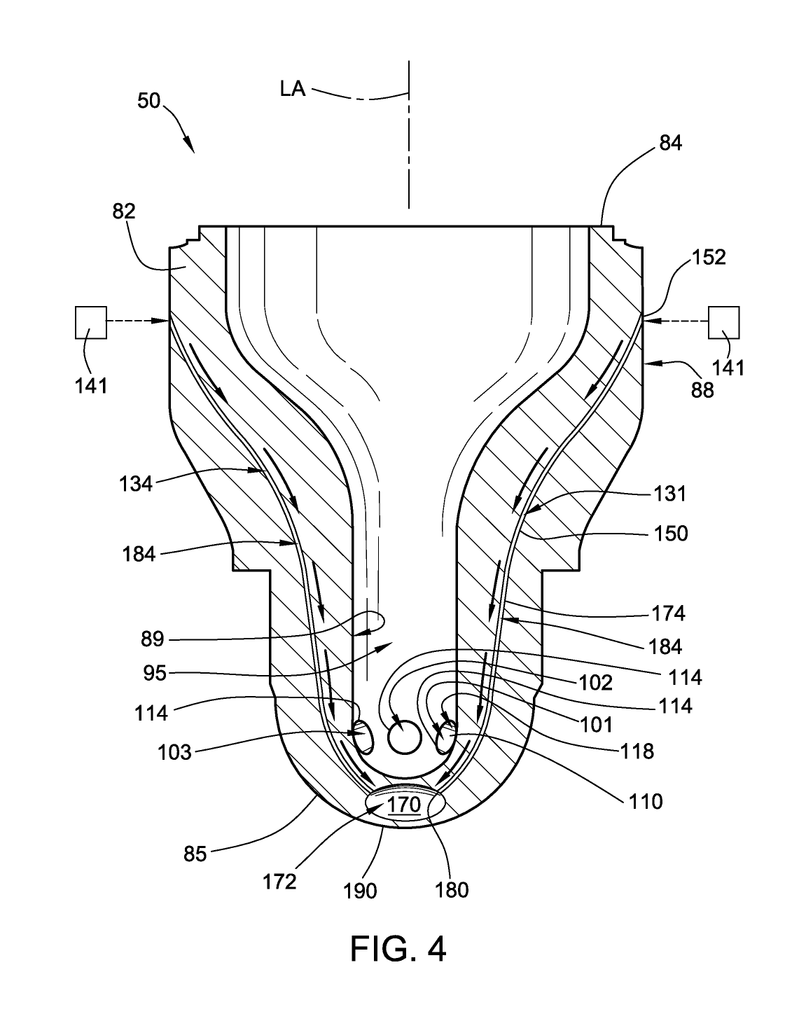

Referring to FIGS. 1 and 4, a source of cooling medium 141 can be placed in fluid communication with the coolant passage 131 and configured such that the source of cooling medium 141 flows through the coolant passage 131 into the orifice passage 118 with which the coolant passage 131 is associated to provide an insulating film of the cooling medium 141 between the orifice surface 110 defining the orifice 101 and the hot burning gases being discharged from the interior chamber 95 of the nozzle body 82.

In embodiments, at least one of the cylinder block 22 and the cylinder head 24 defines one or more cooling medium cavities 144. Each cooling medium cavity 144 can be adapted to be placed in communication with the source of cooling medium 141 and one or more coolant passages 131, 134 defined within the nozzle body 82 and configured to convey the cooling medium 141 to one or more orifices 101, 102, 103, 104, 106 of the nozzle body 82.

In embodiments, the cooling medium 141 can be any suitable kind, such as, a fluid, including air, for example. In embodiments, any suitable technique can be used to convey the source of cooling medium 141 to the coolant passages 131, 134 in the nozzle body 82 for delivery to the orifices 101, 102, 103, 104, 106. In embodiments where the cooling medium 141 is delivered under pressure to the coolant passages 131, 134, each cooling medium cavity 144 can be substantially sealed with a suitable sealing device 52 to help prevent the loss of pressure in the cooling medium 141.

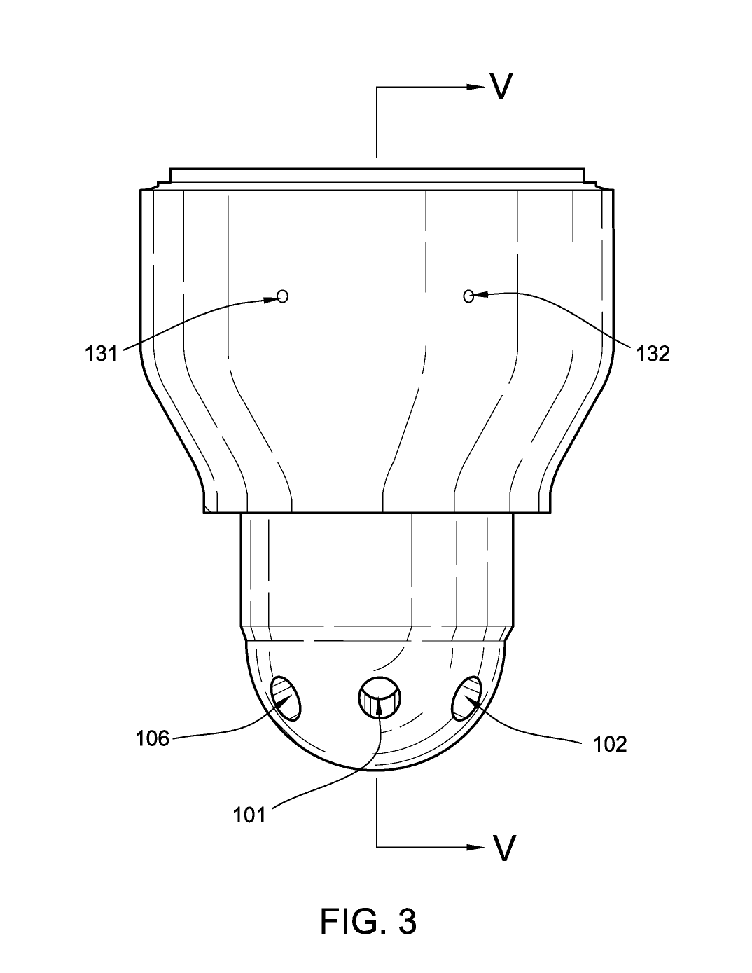

Referring to FIGS. 2-5, the illustrated nozzle body 82 defines a plurality of coolant passages 131, 132, 134, 136. In embodiments, the nozzle body 82 can define any suitable number of coolant passages to achieve the desired heat transfer protective characteristics within the nozzle body 82.

For example, in the illustrated embodiment, the nozzle body 82 includes six coolant passages (four of which are shown in FIGS. 2-5 with the third and fifth coolant passages being similarly configured and mirror images of the sixth and second coolant passages 136, 132, respectively). In the illustrated embodiment, the nozzle body 82 defines an equal number of orifices 101, 102, 103, 104, 106 and coolant passage 131, 132, 134, 136. In other embodiments, the number of orifices and coolant passages can be different from each other.

The six coolant passages 131, 132, 134, 136 are circumferentially arranged about the central longitudinal axis LA at substantially evenly-spaced angular positions (about sixty degrees apart from each other). In the illustrated embodiment, the coolant passages 131, 132, 134, 136 are circumferentially arranged about the central longitudinal axis LA such that they are circumferentially offset with respect to the orifices 101, 102, 103, 104, 106 in interposing relationship between adjacent orifices 101, 102, 103, 104, 106. In embodiments, the coolant passages 131, 132, 134, 136 can be circumferentially arranged about the central longitudinal axis LA such that they have a different relationship with one or more of the orifices 101, 102, 103, 104, 106 defined within the nozzle body 82.

The coolant passages 131, 132, 134, 136 are axially aligned along the central longitudinal axis LA with respect to each other. In other embodiments, at least one coolant passage can be axially offset with respect to at least one other coolant passage defined within the nozzle body 82.

The illustrated coolant passage 131, 132, 134, 136 are substantially identical to each other. Accordingly, it will be understood that the description of one coolant passage is applicable to the other coolant passages, as well. In other embodiments, at least one coolant passage has a configuration that is different from at least one other coolant passage defined in the nozzle body 82.

Referring to FIGS. 4 and 5, the nozzle body 82 includes a coolant surface 150 that defines the first coolant passage 131 within the nozzle body 82. The outer surface 88 of the nozzle body 82 defines a coolant passage inlet opening 152 (see FIG. 4). The orifice surface 110 defines a coolant passage outlet opening 154 which is in communication with the orifice passage 118 (see FIG. 5). In embodiments, the coolant passage 131 extends between, and in communication with, the coolant passage inlet opening 152 and the coolant passage outlet opening 154. The coolant passage 131 is in communication with the orifice passage 118 of the first orifice 101.

In embodiments, the coolant surface 150 can be configured to have a shape that is complementary to the shape of the outer surface 88 and/or the inner surface 89. In embodiments, the shape of the coolant surface 150 can be configured to be substantially aligned with a geometric midpoint between the outer surface 88 and the inner surface 89 as it extends along the central longitudinal axis LA. In other embodiments, the coolant surface 150 can have a different configuration that follows a thermal conduction path defined by the interior volume of the nozzle body 82 between the outer surface 88 and the inner surface 89.

The source of cooling medium 141 is in fluid communication with the first coolant passage 131 via the coolant passage inlet opening 152. The source of cooling medium 141 is configured to flow into the coolant passage inlet opening 152, through the coolant passage 131, out the coolant passage outlet opening 154, and into the orifice passage 118 of the first orifice 101. In embodiments, the source of cooling medium 141 is configured to flow into the orifice passage 118 along a coolant orifice flow path. In embodiments, the coolant orifice flow path is interposed between the orifice surface 110 and a flow of a flame front of ignited mixture from within the interior chamber 95 out through the orifice passage 118 which occurs during the intended operation of the fuel combustion system 20.

In embodiments, the source of cooling medium 141 is configured such that the source of cooling medium 141 disposed within the first coolant passage 131 at the coolant passage outlet opening 154 is at a coolant pressure which is greater than an orifice pressure within the orifice passage 118 of the first orifice 101. The pressure differential between the cooling medium 141 at the coolant passage outlet opening 154 and the orifice pressure can help ensure that the cooling medium 141 flows into the orifice passage 118 of the first orifice 101 to provide an insulative layer of cooling medium against the orifice surface 110. Without intending to be bound by any particular theory, it is believed that the effects of capillary action and/or gravity can help the cooling medium 141 come into contacting relationship with the orifice surface 110 upon entering the first orifice.

In embodiments, the fuel combustion system 20 is configured to convey the cooling medium 141 such that each of the coolant passages 131, 132, 134, 136 has a suitable cooling medium 141 flowing therethrough. In operation, the cooling medium 141 can substantially continuously flow through each of the coolant passages 131, 132, 134, 136 into a respective orifice 101, 102, 103, 104, 106. In embodiments, the cooling medium 141 comprises any suitable material. For example, in embodiments, the cooling medium 141 can comprise any suitable coolant material configured to provide a thermally-insulative boundary layer between the orifice surface 110 and a flow of a flame front being discharged from the interior chamber 95 of the nozzle body 82. In some embodiments, the source of cooling medium 141 comprises a suitable fluid, such as, air, for example. In embodiments, the interaction between the nozzle body 82 and the cooling medium 141 can be varied by adjusting the flow rate of the cooling medium 141 through the coolant passages 131, 132, 134, 136 and/or changing the size, configuration, and/or location of one or more of the coolant passages 131, 132, 134, 136.

Referring to FIGS. 4 and 5, in the illustrated embodiment, the coolant passage inlet opening 152 of the first coolant passage 131 is closer to the mounting end 84 along the central longitudinal axis LA than the coolant passage outlet opening 154 is. In other embodiments, the coolant passage inlet opening 152 and the coolant passage outlet opening 154 can have a different relationship with respect to each other along the central longitudinal axis LA.

Referring to FIG. 5, in the illustrated embodiment, the orifice surface 110 of the first orifice 101 has a proximal top portion 156 and a distal bottom portion 158. The proximal top portion 156 is closer to the mounting end 84 than is the distal bottom portion 158. The distal bottom portion 158 defines the coolant passage outlet opening 154. In the illustrated embodiment, the illustrated coolant passage outlet opening 154 is closer to the inner orifice opening 114 along the orifice axis OA₁ than to the outer orifice opening 112.

The cooling medium 141 conveyed through the coolant passage 131 into the orifice 101 can flow from the coolant passage outlet opening 154 down toward the outer orifice opening 112 of the first orifice 101 via the effect of gravity and/or the flow of a flame front discharging from the interior chamber 95 of the nozzle body. The flow of cooling medium 141 dispensed from the coolant passage outlet 154 can spread against the orifice surface 110 outwardly in a direction transverse to the orifice axis OA₁ as it flows along the orifice axis OA₁ of the first orifice 101 toward the outer orifice opening 112. In other embodiments, the coolant passage outlet 154 can be placed in a different location within the orifice 101.

Referring to FIGS. 4 and 5, in the illustrated embodiment, the nozzle body 82 includes a reservoir surface 170 that defines a distribution reservoir 172 disposed between the outer surface 88 and the inner surface 89 of the nozzle body 82. In the illustrated embodiment, the distribution reservoir 172 is in communication with each coolant passage 131, 132, 134, 136 of the nozzle body 82.

The illustrated coolant surface 150 of the first coolant passage 131 comprises the reservoir surface 170, a coolant feed surface 174 (FIG. 4), and a coolant distribution surface 178 (FIG. 5). The reservoir surface 170 is interposed between the coolant feed surface 174 and the coolant distribution surface 178. The reservoir surface 170 defines a reservoir inlet opening 180 (FIG. 4) and a reservoir outlet opening 182 (FIG. 5). The coolant feed surface 174 defines a coolant feed conduit 184 extending between, and in communication with, the coolant passage inlet opening 152 and the reservoir inlet opening 180. The coolant distribution surface 178 defines a coolant distribution conduit 188 extending between, and in communication with, the reservoir outlet opening 182 and the coolant passage outlet opening 154.

The other coolant passages 132, 133, 134 of the nozzle body 82 are configured substantially the same as the first coolant passage 131. The distribution reservoir 172, therefore, is in communication with each of the coolant passages 131, 132, 133, 134 of the nozzle body. As will be appreciated, the cooling medium 141 flowing into the distribution reservoir 172 from a given coolant feed conduit 184 can exit the distribution reservoir 172 via one or more of the coolant distribution conduits 188, depending upon how the cooling medium 141 flowing in from the coolant feed conduits 184 interacts within the distribution reservoir 172. Therefore, a coolant passage can include any one of the coolant feed conduits 184, the distribution reservoir 172, and any one of the distribution conduits 188.

The illustrated coolant feed conduits 184 and coolant distribution conduits 188 each has a generally circular transverse cross-sectional shape which is substantially uniform along its axial length. In other embodiments, at least one of the coolant feed conduits 184 and/or the coolant distribution conduits 188 can be different. In embodiments, the number of coolant feed conduits 184 can be different from the number of coolant distribution conduits 188. In embodiments, more than one coolant feed distribution conduit 188 can be in communication with a given orifice.

The illustrated distal tip 85 includes a spherical cap portion 190. The illustrated reservoir surface 170 is disposed in the spherical cap portion located distally along the central longitudinal axis LA relative to the inner orifice opening 114 of each of the orifices 101, 102, 103, 104, 106. In other embodiments, the reservoir surface 170 can be positioned in another location within the nozzle body 82. For example, in embodiments, the reservoir surface 170 can be positioned proximally along the central longitudinal axis LA relative to the inner orifice opening 114 of each of the orifices 101, 102, 103, 104, 106 such that the effect of gravity urges the cooling medium 141 to flow from the distribution reservoir 172 to the orifices 101, 102, 103, 104, 106 through respective coolant distribution conduits 188.

Embodiments of a nozzle for a prechamber assembly constructed according to principles of the present disclosure can have a nozzle body that includes at least one coolant passage configured to deliver a flow of cooling medium into at least one orifice to coat the orifice surface(s) with a film of cooling medium conveyed under pressure through the coolant passage(s) in communication with the orifice passage(s). In operation, the heat transfer effects of a flow of an air/fuel mixture into the prechamber nozzle and/or a flame front discharging from the prechamber nozzle alternately passing through the orifices of the nozzle during intended operation of the fuel combustion system are reduced by conveying a flow of cooling medium through the orifices via a network of coolant passages defined within the nozzle body and in communication with the orifices.

It will be apparent to one skilled in the art that various aspects of the disclosed principles relating to fuel combustion systems and fuel combustion components can be used with a variety of engines. Accordingly, one skilled in the art will understand that, in other embodiments, an engine following principles of the present disclosure can include different fuel combustion components constructed according to principles of the present disclosure and can take on different forms.

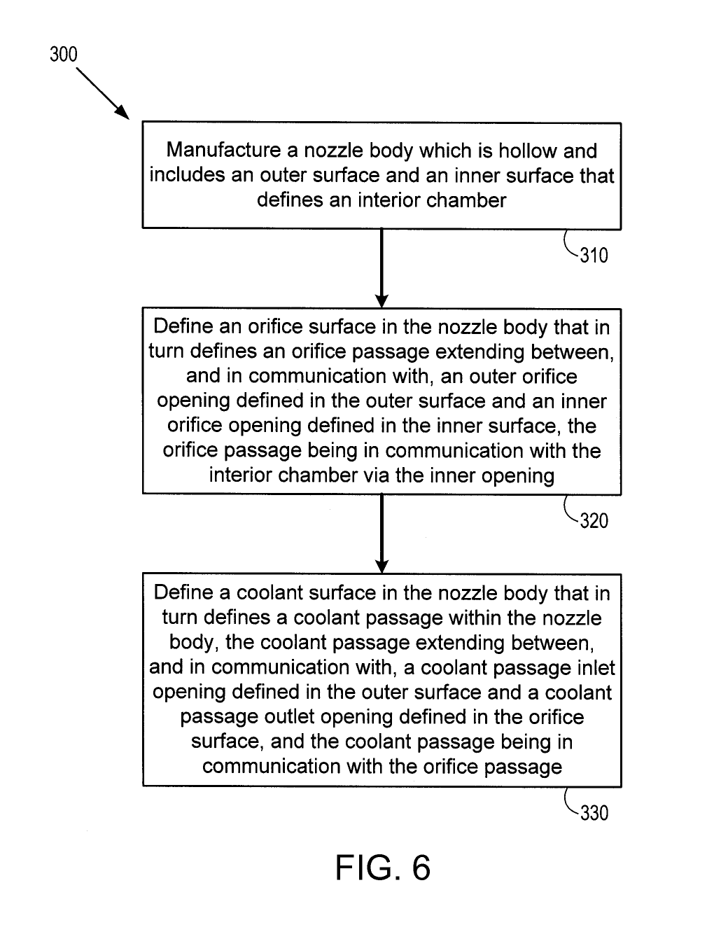

Referring to FIG. 6, steps of an embodiment of a method 300 of making a nozzle for a prechamber assembly of an engine following principles of the present disclosure are shown. In embodiments, a method of making a nozzle for a prechamber assembly of an engine following principles of the present disclosure can be used to make any embodiment of a nozzle for a prechamber assembly according to principles of the present disclosure. In other embodiments, the nozzle body can be any suitable nozzle body for use in a fuel combustion system.

The illustrated method 300 of making a nozzle for a prechamber assembly includes manufacturing a nozzle body (step 310). The nozzle body is hollow and includes an outer surface and an inner surface. The inner surface defines an interior chamber. In embodiments, the body is manufactured from a suitable material, such as a metal alloy. In embodiments, the body is made from at least one of a nickel alloy and a steel.

An orifice surface is defined in the nozzle body (step 320). The orifice surface defines an orifice passage extending between, and in communication with, an outer orifice opening defined in the outer surface and an inner orifice opening defined in the inner surface. The orifice passage is in communication with the interior chamber via the inner orifice opening.

A coolant surface is defined in the nozzle body (step 330). The coolant surface defines a coolant passage within the nozzle body. The coolant passage extends between, and is in communication with, a coolant passage inlet opening defined in the outer surface and a coolant passage outlet opening defined in the orifice surface. The coolant passage is in communication with the orifice passage.

In embodiments of a method of making a nozzle for a prechamber assembly following principles of the present disclosure, the nozzle body is manufactured and the coolant surface is defined via additive manufacturing (also sometimes referred to as “additive layer manufacturing” or “3D printing”). In embodiments, any suitable additive manufacturing equipment can be used. For example, in embodiments, a production 3D printer commercially available under the under the brand name ProX™ 200 from 3D Systems, Inc. of Rock Hill, S.C., can be used. In embodiments of a method of making a nozzle for a prechamber assembly following principles of the present disclosure, the nozzle body is manufactured and the orifice surface and the coolant surface are defined all via additive manufacturing. In still other embodiments, the nozzle body is manufactured and each orifice surface and each coolant surface is defined together via additive manufacturing, and each orifice passage and coolant passage is defined within the nozzle body substantially simultaneously with its manufacture.

In embodiments of a method of making a nozzle for a prechamber assembly following principles of the present disclosure, the orifice surface is defined such that the orifice surface extends along an orifice axis between the inner orifice opening and the outer orifice opening. The coolant passage outlet opening is defined such that the coolant passage outlet opening is closer to the inner orifice opening along the orifice axis than to the outer orifice opening.

In embodiments, the nozzle body includes a mounting end and a distal tip. The nozzle body defines a central longitudinal axis extending between the mounting end and the distal tip. The orifice surface is disposed within the distal tip. The coolant passage inlet opening is closer to the mounting end along the central longitudinal axis than the coolant passage outlet opening is.

In embodiments, the orifice surface has a proximal top portion and a distal bottom portion. The proximal top portion is closer to the mounting end than is the distal bottom portion. The distal bottom portion defines the coolant passage outlet opening.

In other embodiments of a method of making a nozzle for a prechamber assembly following principles of the present disclosure, the nozzle body is made such that the nozzle body includes a reservoir surface. The reservoir surface defines a distribution reservoir disposed between the outer surface and the inner surface. The distribution reservoir is in communication with the coolant passage. The reservoir surface defines a reservoir inlet opening and a reservoir outlet opening. The coolant surface includes a coolant feed surface and a coolant distribution surface. The coolant feed surface defines a coolant feed conduit extending between, and in communication with, the coolant passage inlet opening and the reservoir inlet opening. The coolant distribution surface defines a coolant distribution conduit extending between, and in communication with, the reservoir outlet opening and the coolant passage outlet opening.

### INDUSTRIAL APPLICABILITY

The industrial applicability of the embodiments of a fuel combustion system, a nozzle for a prechamber assembly, and a method of making the same as described herein will be readily appreciated from the foregoing discussion. At least one embodiment of a prechamber assembly constructed according to principles of the present disclosure can be used in an engine to help operate the engine with a lean fuel/air ratio. Embodiments of a nozzle and/or a prechamber assembly according to principles of the present disclosure may find potential application in any suitable engine. Exemplary engines include those used in electrical generators and pumps, for instance.

For example, in some internal combustion engines, the energy of an ignition spark may not be sufficient to ignite reliably the combustion gas/air mixture, which for emissions reasons is often very lean, in the main combustion chamber. To increase the ignition energy, a prechamber assembly constructed according to principles of the present disclosure can be connected to the cylinder head and placed in communication with the main combustion chamber via a plurality of orifices defined in the nozzle. A small part of the mixture is enriched with a small quantity of combustion gas or an additional fuel and ignited in the precombustion chamber.

Flame propagation, i.e. ignition kernel, is transferred to the main combustion chamber by way of the orifices in the nozzle and the flame propagation ignites the lean fuel mixture. The flame discharge pattern from the orifices can spread the flame pattern outwardly such that the flame area in the main combustion chamber is increased. The discharge flame pattern emitting from the nozzle is advantageous because it has a hot surface area that can ignite even extremely lean or diluted combustible mixtures in a repeatable manner.

Embodiments of a nozzle for a prechamber assembly constructed according to principles of the present disclosure can have a nozzle body that includes at least one coolant passage configured to help protect an orifice defined within the nozzle body from the deleterious effects of the flow of an air-fuel mixture into the prechamber nozzle and/or a flame front discharging from the prechamber nozzle respectively passing through the orifice of the nozzle during intended operation of the fuel combustion system. In embodiments, the nozzle can include at least one coolant passage in communication with an orifice passage defined within the nozzle body. A source of cooling medium can be placed in fluid communication with the coolant passage and configured such that the source of cooling medium flows through the coolant passage into the orifice passage to provide an insulating film of cooling medium between the orifice surface defining the orifice passage and the hot burning gases being discharged from the interior chamber of the nozzle.

In embodiments, a nozzle constructed according to principles of the present disclosure defines a distribution reservoir therein. The nozzle body defines at least one coolant passage therein which is in fluid communication with the distribution reservoir, which in turn is in fluid communication with at least one orifice passage defined within the nozzle body. A cooling flow of a cooling medium is routed to the distribution reservoir within the nozzle body. The cooling medium is fed from the distribution reservoir to at least one orifice passage to create an insulating film of cooling medium between the orifice surface defining the orifice passage and the flow of an air-fuel mixture into the prechamber nozzle and/or a flame front discharging from the prechamber nozzle.

The configuration of the coolant passage(s) in the nozzle body and the association of a source of cooling medium therewith for delivery into the orifice(s) of the nozzle body can increase the useful life of the fuel combustion component and help it withstand the ablative nature of the flows of fuel mixture/flame front passing through the orifice(s). The insulative nature of the cooling medium introduced into the orifice(s) as a film interposed between the orifice surface(s) and the flow of an air-fuel mixture/flame front can help reduce the amount of heat-induced damage suffered by the nozzle during operation. Embodiments of a prechamber nozzle constructed according to principles of the present disclosure can be made using additive manufacturing techniques.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A nozzle for a prechamber assembly of an engine, the nozzle comprising:
a nozzle body, the nozzle body being hollow and including an outer surface, an inner surface, and an orifice surface, the outer surface defining an outer orifice opening and a coolant passage inlet opening, the inner surface defining an interior chamber and an inner orifice opening, and the orifice surface defining an orifice passage extending between, and in communication with, the outer orifice opening and the inner orifice opening, the orifice passage being in communication with the interior chamber via the inner orifice opening, the orifice surface defining a coolant passage outlet opening, the coolant passage outlet opening in communication with the orifice passage;
wherein the nozzle body includes a coolant surface, the coolant surface defining a coolant passage within the nozzle body, the coolant passage extending between, and in communication with, the coolant passage inlet opening and the coolant passage outlet opening, and the coolant passage being in communication with the orifice passage.

2. The nozzle according to claim 1, wherein the nozzle body includes a mounting end and a distal tip, the nozzle body defining a central longitudinal axis extending between the mounting end and the distal tip, the orifice surface being disposed within the distal tip, the coolant passage inlet opening being closer to the mounting end along the central longitudinal axis than the coolant passage outlet opening is.

3. The nozzle according to claim 1, wherein the nozzle body includes a second orifice surface, the outer surface defines a second outer orifice opening and a second coolant passage inlet opening, the inner surface defines a second inner orifice opening, and the second orifice surface defines a second orifice passage extending between, and in communication with, the second outer orifice opening and the second inner orifice opening, the second orifice passage being in communication with the interior chamber via the second inner orifice opening, the second orifice surface defining a second coolant passage outlet opening, the second coolant passage outlet opening in communication with the second orifice passage, and wherein the nozzle body includes a second coolant surface, the second coolant surface defining a second coolant passage within the nozzle body, the second coolant passage extending between, and in communication with, the second coolant passage inlet opening and the second coolant passage outlet opening.

4. The nozzle according to claim 1, wherein the orifice surface extends along an orifice axis between the inner orifice opening and the outer orifice opening, and the coolant passage outlet opening is closer to the inner orifice opening along the orifice axis than to the outer orifice opening.

5. The nozzle according to claim 4, wherein the nozzle body includes a mounting end and a distal tip, the nozzle body defining a central longitudinal axis extending between the mounting end and the distal tip, the orifice surface being disposed within the distal tip, the orifice surface has a proximal top portion and a distal bottom portion, the proximal top portion being closer to the mounting end than is the distal bottom portion, and the distal bottom portion defining the coolant passage outlet opening.

6. The nozzle according to claim 1, wherein the nozzle body includes a reservoir surface, the reservoir surface defining a distribution reservoir disposed between the outer surface and the inner surface, the distribution reservoir being in communication with the coolant passage, the reservoir surface defines a reservoir inlet opening and a reservoir outlet opening, and the coolant surface includes a coolant feed surface and a coolant distribution surface, the coolant feed surface defining a coolant feed conduit extending between, and in communication with, the coolant passage inlet opening and the reservoir inlet opening, and the coolant distribution surface defining a coolant distribution conduit extending between, and in communication with, the reservoir outlet opening and the coolant passage outlet opening.

7. The nozzle according to claim 6, wherein the nozzle body includes a mounting end and a distal tip, the nozzle body defining a central longitudinal axis extending between the mounting end and the distal tip, the distal tip including a spherical cap portion, the reservoir surface disposed in the spherical cap portion.

8. The nozzle according to claim 6, wherein the outer surface defines a second coolant passage inlet opening, the reservoir surface defines a second reservoir inlet opening, and the nozzle body includes a second coolant feed surface, the second coolant feed surface defining a second coolant feed conduit extending between, and in communication with, the second coolant passage inlet opening and the second reservoir inlet opening.

9. The nozzle according to claim 6, wherein the nozzle body includes a second orifice surface, the outer surface defines a second outer orifice opening, the inner surface defines a second inner orifice opening, and the second orifice surface defines a second orifice passage extending between, and in communication with, the second outer orifice opening and the second inner orifice opening, the second orifice passage being in communication with the interior chamber via the second inner orifice opening, the second orifice surface defining a second coolant passage outlet opening, the second coolant passage outlet opening in communication with the second orifice passage, and wherein the nozzle body includes a second coolant distribution surface, and the reservoir surface defines a second reservoir outlet opening, and the second coolant distribution surface defining a second coolant distribution conduit extending between, and in communication with, the second reservoir outlet opening and the second coolant passage outlet opening.

10. The nozzle according to claim 9, wherein the outer surface defines a second coolant passage inlet opening, the reservoir surface defines a second reservoir inlet opening, and the nozzle body includes a second coolant feed surface, the second coolant feed surface defining a second coolant feed conduit extending between, and in communication with, the second coolant passage inlet opening and the second reservoir inlet opening.

11. A fuel combustion system comprising:
a cylinder housing, the cylinder housing defining a main combustion chamber;
a prechamber assembly, the prechamber assembly in communication with the main combustion chamber, the prechamber assembly defining a precombustion chamber, the precombustion chamber in communication with the main combustion chamber, the prechamber assembly including a prechamber housing, an ignition device adapted to selectively ignite a fuel supply disposed in the precombustion chamber, and a nozzle, the ignition device mounted to the prechamber housing, the nozzle adjacent the prechamber housing, the nozzle at least partially defining the precombustion chamber, the nozzle including:
a nozzle body, the nozzle body being hollow and including an outer surface, an inner surface, and an orifice surface, the outer surface defining an outer orifice opening and a coolant passage inlet opening, the inner surface defining an interior chamber and an inner orifice opening, and the orifice surface defining an orifice passage extending between, and in communication with, the outer orifice opening and the inner orifice opening, the orifice passage being in communication with the interior chamber via the inner orifice opening and with the main combustion chamber via the outer orifice opening, the orifice surface defining a coolant passage outlet opening, the coolant passage outlet opening in communication with the orifice passage, and
wherein the nozzle body includes a coolant surface, the coolant surface defining a coolant passage within the nozzle body, the coolant passage extending between, and in communication with, the coolant passage inlet opening and the coolant passage outlet opening, and the coolant passage being in communication with the orifice passage.

12. The fuel combustion system according to claim 11, further comprising:
a source of cooling medium, the source of cooling medium in fluid communication with the coolant passage via the coolant passage inlet opening, the source of cooling medium configured to flow into the coolant passage inlet opening, through the coolant passage, out the coolant passage outlet opening, and into the orifice passage.

13. The fuel combustion system according to claim 12, wherein the source of cooling medium is configured to flow into the orifice passage along a coolant orifice flow path, the coolant orifice flow path interposed between the orifice surface and a flow of a flame front of ignited mixture from within the interior chamber out through the orifice passage.

14. The fuel combustion system according to claim 12, wherein the source of cooling medium is configured such that the source of cooling medium disposed within the coolant passage at the coolant passage outlet opening is at a coolant pressure, and the orifice passage has an orifice pressure, the coolant pressure being greater than the orifice pressure.

15. The fuel combustion system according to claim 14, wherein the nozzle body of the nozzle includes a reservoir surface, the reservoir surface defining a distribution reservoir disposed between the outer surface and the inner surface, the distribution reservoir being in communication with the coolant passage, the reservoir surface defines a reservoir inlet opening and a reservoir outlet opening, and the coolant surface includes a coolant feed surface and a coolant distribution surface, the coolant feed surface defining a coolant feed conduit extending between, and in communication with, the coolant passage inlet opening and the reservoir inlet opening, and the coolant distribution surface defining a coolant distribution conduit extending between, and in communication with, the reservoir outlet opening and the coolant passage outlet opening.

16. A method of making a nozzle for a prechamber assembly of an engine, the method of making comprising:
manufacturing a nozzle body, the nozzle body being hollow and including an outer surface and an inner surface, the inner surface defining an interior chamber;
defining an orifice surface in the nozzle body, the orifice surface defining an orifice passage extending between, and in communication with, an outer orifice opening defined in the outer surface and an inner orifice opening defined in the inner surface, the orifice passage being in communication with the interior chamber via the inner orifice opening;
defining a coolant surface in the nozzle body, the coolant surface defining a coolant passage within the nozzle body, the coolant passage extending between, and in communication with, a coolant passage inlet opening defined in the outer surface and a coolant passage outlet opening defined in the orifice surface, the coolant passage in communication with the orifice passage.

17. The method of making according to claim 16, wherein the orifice surface is defined such that the orifice surface extends along an orifice axis between the inner orifice opening and the outer orifice opening, and the coolant passage outlet opening is defined such that the coolant passage outlet opening is closer to the inner orifice opening along the orifice axis than to the outer orifice opening.

18. The method of making according to claim 16, wherein the nozzle body is made such that the nozzle body includes a reservoir surface, the reservoir surface defining a distribution reservoir disposed between the outer surface and the inner surface, the distribution reservoir being in communication with the coolant passage, the reservoir surface defines a reservoir inlet opening and a reservoir outlet opening, and the coolant surface includes a coolant feed surface and a coolant distribution surface, the coolant feed surface defining a coolant feed conduit extending between, and in communication with, the coolant passage inlet opening and the reservoir inlet opening, and the coolant distribution surface defining a coolant distribution conduit extending between, and in communication with, the reservoir outlet opening and the coolant passage outlet opening.

19. The method of making according to claim 16, wherein the nozzle body is manufactured and the coolant surface is defined via additive manufacturing.

20. The method of making according to claim 19, wherein the orifice surface is defined via additive manufacturing.
